(19) United States
(12) Patent Application Publication
(10) Pub. No.: US 2023/0079880 A1
(43) Pub. Date: Mar. 16, 2023

(54) RECONFIGURABLE VEHICLE BODY

(71) Applicant: J. MAC SAFETY SYSTEMS LIMITED, Stockton-on-Tees (GB)

(72) Inventor: Luis MCCARTHY, Durham, Stockton-on-Tees (GB)

(73) Assignee: J. MAC SAFETY SYSTEMS LIMITED, Stockton-on-Tees (GB)

(21) Appl. No.: 17/800,861

(22) PCT Filed: Feb. 17, 2021
(86) PCT No.: PCT/GB2021/050382

§ 371 Date: Aug. 18, 2022

(30) Foreign Application Priority Data
Feb. 21, 2020 (GB) 2002447.7

(51) Int. Cl. B60P 1/64; B62D 33/02; B65D 88/12; B65D 90/00; B65D 90/18

(52) U.S. Cl. CPC B60P 1/64; B62D 33/0207; B65D 88/129; B65D 90/0066; B65D 90/0033; B65D 90/18; B65D 2590/005

(57) ABSTRACT

A reconfigurable vehicle body having a main body including at least one elongate main beam, a load deck mounted relative to the at least one elongate main beam and at least one forward headboard structure at a forward end of the load deck is disclosed. At least two pairs of fixed posts provided in a rear portion of the load deck, one fixed post of each pair located at an opposed lateral side of the load deck and extending upwardly relative to the load deck, a wall-receiving assembly positioned relative to each of the fixed posts and at least one removable wall member locatable relative to at least a pair of wall-receiving assemblies to define at least one receiving compartment within the width of the load deck is present.

### TECHNICAL FIELD OF THE INVENTION

The present invention relates generally to a vehicle body and more particularly to a vehicle body which is reconfigurable to provide a variety of portions or compartments of different sizes, for different purposes.

### BACKGROUND TO THE INVENTION

A demountable body is a type of truck body that is commonly used in the distribution industry. Demountable bodies (usually a box body) are used to enable the truck to do more work during the permitted driving hours for the driver by reducing loading time.

The demountable body is mounted on a frame and fitted with legs, allowing the body to be demounted from the truck and stand in a self-supporting configuration when not in transit on the truck.

A truck using a demountable body will usually drop one or more empty units at the depot and pick up full units. The truck will then drive the units to the customer. In some cases, the truck drops the full units, and collects empty units or in other cases, delivers to the customer where the unit is unloaded at one or more drops.

The ability to switch units has several other advantages including better utilisation of the truck and units, ability to reassign a delivery to another driver if traffic delays a vehicle or it breaks down.

Conventional demountable bodies are provided in fixed configurations with the advantages to be gained from using demountable bodies, gained from the ability to pre-load a demountable body or container to be loaded and unloaded from a demountable body, before a delivery vehicle is available and then simply swap the empty demountable body for a full demountable body.

Embodiments of the invention seek to at least partially overcome or ameliorate any one or more of the abovementioned disadvantages or provide the consumer with a useful or commercial choice.

### SUMMARY OF THE INVENTION

According to an aspect of the present invention, there is provided a reconfigurable vehicle body comprising
a) A main body including
   i. At least one elongate main beam
   ii. A load deck mounted relative to the at least one elongate main beam and
   iii. At least one forward headboard structure at a forward end of the load deck
b) At least two pairs of fixed posts provided in a rear portion of the load deck, one fixed post of each pair located at an opposed lateral side of the load deck and extending upwardly relative to the load deck
c) A wall-receiving assembly positioned relative to each of the fixed posts and
d) At least one removable wall member locatable relative to at least a pair of wall-receiving assemblies to define at least one receiving compartment within the width of the load deck.

Providing at least two pairs of fixed posts in a rear portion of the load deck with one fixed post of each pair on opposed lateral sides extremities of the load deck with a wall receiving assembly positioned relative to each of the fixed posts and at least one removable wall member locatable relative to at least a pair of wall receiving assemblies, enables the vehicle body of the present invention to be reconfigurable, in at least a part thereof, in order to accept a wider variety of loads.

In an embodiment, the vehicle body is a demountable body, configured to be mounted and demounted from a vehicle.

In an embodiment, the vehicle body is a demountable truck body, configured to be mounted and demounted from a vehicle.

Whilst the reconfigurable vehicle body of the present invention is adaptable to a wide variety of uses, in the context of the present description, it is particularly but not exclusively adapted for use in delivery of scaffold system components allowing a scaffold system to be assembled from the delivered components.

The reconfigurable vehicle body of the present invention comprises a main body including at least one elongate beam, a load deck mounted relative to the at least one elongate main beam and at least one forward headboard structure at a forward end of the load deck.

In a preferred form, the main body will have a sledge configuration. The or each main beam may provide a runner or rest upon which the main body rests when on a ground surface (or while not on a vehicle).

One or more wheel members may be provided towards a rear end of the main body. In use, a forward end of the main body may be lifted upwardly with the rear end of the main body supported on the one or more wheel members while the main body is drawn onto or driven onto a truck chassis. Preferably, two wheel members will be provided, one on either lateral side of the main body. It is preferred that the wheel members extend further rearwardly than the rear end of the at least one elongate main member such that when the forward end of the main body is lifted, the rear end of the main body is supported on the wheel members.

One or more draw points or assemblies may be provided on a forward end of the vehicle body. In an embodiment, the one or more draw points or assemblies may be used to winch or otherwise draw the preferred demountable vehicle body onto a transport vehicle. In one simple embodiment, one or more plates provided with an opening relative to which a winch cable can be attached, could be used as a draw point.

There will typically be a pair of elongate main beams relative to which other components of the main body are provided. The preferred pair of elongate main beams will typically extend substantially parallel to one another. The preferred pair of elongate main beams will preferably be spaced apart over the length of the main body.

The elongate main beams will preferably be the main load-bearing beams provided in the structure of the main body. Although any cross-sectional shape may be utilised for the at least one elongate main beam, the or each elongate main beam will preferably be an I-beam or a C-section beam.

In an embodiment, a plurality of transversely extending members may be provided above the elongate main beams and attached thereto. Preferably, the transversely extending members will extend laterally beyond the spacing of the elongate main beams. The transversely extending members will preferably support the load deck relative thereto. Each of the transversely extending members will preferably be hollow. Each of the transversely extending members will preferably be substantially rectangular in cross section. Each of the transversely extending members will preferably be rectangular hollow section. Each transversely extending member will preferably be unitary over its length.

As mentioned above, the load deck of the main body will preferably be provided on top of the transversely extending members.

A tailgate assembly will preferably be provided relative to a rear end of the main body. Typically, a pivot or hinge may be provided adjacent to the rear end of the main body and/or one or more securing assemblies.

At least one side rail member may be provided at the lateral side ends of each of the preferred transversely extending members. Typically, one or more side rail members will be provided extending along the length of the main body, at the lateral sides thereof.

The main body includes a load deck mounted relative to the at least one elongate main beam. The load deck will typically be formed from one or more planar plates.

Typically, the load deck will be provided in a single plane and therefore, if formed of more than one plate, the plates will typically be coplanar. Preferably, the load deck is mounted above the preferred transversely extending members.

A removable tailgate post may be provided at either lateral side of the main body, at a rear end of the load deck. The removable tailgate posts will preferably provide an abutment for a tailgate when the tailgate is in the closed position.

The tailgate may be moved between an open position in which the tailgate is preferably substantially horizontal and a closed condition in which the tailgate is preferably substantially vertical. In the closed condition, the tailgate will preferably prevent access to the rear of the main body from outside the main body.

A pivotable tailgate may be provided. The tailgate may be driven between the open position and the closed position. One or more hydraulic rams or similar may be used to drive movement of a pivotable tailgate.

The main body also includes at least one forward headboard structure at a forward end of the load deck. The headboard structure typically is or includes a substantially planar structure. The headboard structure will preferably include a pair of members which extend substantially perpendicularly to the at least one elongate main beam. When viewed from the front, the pair of members will typically converge toward an upper portion of the headboard structure. A lower end of each of the pair of members is typically mounted to, or relative to a forward end of each of the respective elongate main beams.

The headboard structure will preferably be substantially perpendicular to the load deck. The headboard structure will preferably include one or more plate members mounted relative to a rear side thereof, facing the load deck. The one or more plate members will preferably provide an abutment surface at a forward end of the load deck.

All of the components of the main body will preferably be manufactured from a material which is strong but light, suitably a light metal. The components will typically be attached relative to one another using an appropriate method. For example, welding may be used if permanent attachment is required. Bolts may be used if temporary attachment is required.

The load deck of the vehicle body of a preferred embodiment is generally divided into a forward portion and a rear portion. The forward portion and rear portion will typically be configured differently and dependent upon the load to be carried. In an embodiment of the invention in which the vehicle body is specifically adapted for transport of parts of a scaffold system, it is preferred that the rear portion of the load deck is configured to carry elongate scaffold members and a forward portion of the load deck is configured to carry connectors and/or shorter scaffold members. The load deck may be divided into the forward portion and the rear portion in any proportions, but a 45:55, forward portion: rear portion split is preferred.

The present invention includes at least two pairs of fixed posts provided in a rear portion of the load deck, one fixed post of each pair located at an opposed lateral side of the load deck and extending upwardly relative to the load deck.

In an embodiment, three or more pairs of fixed posts may be provided. In situations where three pairs of fixed posts are provided in the rear portion of the load deck, the three pairs will typically include a front pair of fixed posts, a rear pair of fixed posts and a central pair of fixed posts located between the front pair and the rear pair of fixed posts. The central pair of fixed posts may be located closer to the rear of the load deck than the front.

One fixed post of each pair will typically be located at opposed lateral sides of the load deck and be designated an outside fixed post. One or more intermediate fixed posts may be provided between the outside fixed posts in a pair. Typically, the intermediate fixed posts may be provided equally spaced across the width of the load deck between the outside fixed posts. A preferred embodiment includes two intermediate fixed posts located between the outside fixed posts in each pair. In this preferred configuration, four fixed posts are provided substantially in line across the width of the load deck. Preferably, three sets of four fixed posts are provided in the rear portion of the load deck.

The intermediate fixed posts may be removable. In one embodiment, a foot assembly may be provided for the mounting of the intermediate fixed posts. The foot assembly may include a shaped foot, recessed into the load deck and relative to which the intermediate fixed posts can be mounted and removed as required. The shaped foot will preferably locate the intermediate fixed posts and orient the intermediate fixed posts.

It is preferred that the fixed posts in the rear portion of the load deck form a regular array. A preferred form of regular array has 12 fixed posts arrayed in three lines spaced over the length of the rear portion, each line having four fixed posts spaced across the width of the load deck.

The rear pair of fixed posts is typically located inside the preferred tailgate assembly. Preferably, the rear pair of fixed posts is located inside a removable tailgate post provided on either lateral side of the rear of the load deck.

The fixed posts may be mounted to/relative to the load deck.

The fixed posts typically extend above the level of the load deck. The fixed posts may extend upwardly above the load deck any distance. In one form, the fixed posts each extend above the load deck approximately 1 m to 1.2 m.

In an alternative form, the fixed posts may be relatively short mounting portions relative to which one or more longer, removable posts can then be positioned, as and when required. The provision of the fixed posts as relatively short mounting portions may allow greater flexibility of configuration, and particularly access to the rear portion of the load deck by allowing the longer, removable posts to be added and removed as desired.

The fixed posts will typically be elongate. The fixed posts will typically be at least partially hollow. The fixed posts are preferably configured as rectangular hollow section or square hollow section.

One or more removable upper post sections will preferably be mountable relative to an upper end of each fixed post. Preferably, the removable upper post sections will be at least partially received within an upper portion of each fixed post. A stop or abutment configuration will preferably be provided spaced from the lower end of the removable upper post section in order to limit insertion of the upper post section into the fixed post. Typically, the removable upper post section will be shaped and dimensioned to be closely received within a hollow upper end of each fixed post. A friction fit is preferred.

The vehicle body of the present invention includes a wall receiving assembly positioned relative to each of the fixed posts. The wall receiving assembly preferably functions to receive a removable wall panel.

Each wall receiving assembly will typically include a pair of spaced apart receiving arms. In one form, the receiving arms are substantially planar plates. The wall receiving assembly is preferably dimensioned to allow insertion and removal of a removable wall panel. Typically, the wall receiving assembly will be substantially vertically oriented such that a removable wall panel can be inserted by sliding the wall panel into the wall receiving assembly from above. There will generally be a small clearance between the thickness of the removable wall panel and the preferred spaced apart receiving arms.

In one form, an outer receiving arm of each wall receiving assembly is typically a planar plate. The preferred planar plate will typically be mounted relative to a portion of a fixed post.

An inner receiving arm of each wall receiving assembly is typically provided as a part of an angled member. Preferably, the angle member will be a substantially L-shaped member with a pair of walls which are substantially perpendicular to one another. A rolled steel angle is particularly preferred. One of the arms of each angle member will preferably be positioned parallel to and spaced from the preferred outer receiving arm in order to define a receiving gap into which a removable wall panel can be inserted.

In an embodiment, both an outer receiving arm and angle including an inner receiving arm are preferably attached to a lower portion of each fixed post. Typically, the preferred outer receiving arm is attached or mounted to an outer wall of each fixed post. The preferred angle member is typically attached or mounted to a side wall of each fixed post in order to position the inner receiving arm relative to the outer receiving arm.

The preferred front pair of fixed posts and rear pair of fixed posts will typically each have one wall receiving assembly. The central pair of fixed posts will typically have a wall receiving assembly extending from each end thereof, facing the respective front pair of fixed posts or rear pair of fixed posts.

A wall receiving assembly is preferably provided on all intermediate fixed posts in order to allow the rear portion of the load deck to be divided into a number of compartments spaced across the width of the load deck, through the provision of removable wall panels.

The vehicle body of the present invention includes at least one removable wall member located relative to at least a pair of wall receiving assemblies to define at least one receiving compartment within the width of the load deck.

Each of the removable wall members will preferably be formed from a strong, rigid material such as a light metal for example. In a preferred form, each of the removable wall members is or includes a metal plate.

Typically, a single removable wall member is provided between each fixed post, longitudinally. The removable wall members will typically be planar.

Each removable wall member will typically include at least one lifting opening provided through the removable wall member. A pair of lifting openings is preferred.

Provision of a pair of spaced apart lifting openings will typically allow a mechanism or machine such as a forklift having a pair of spaced apart tines to be used to insert and remove the removable wall members, which may be quite heavy dependent upon size and material of construction. Preferably the pair of lifting openings are spaced apart a regular distance in order to accommodate forklift tines which may have a fixed separation distance.

Where one or more openings through the removable wall member are provided, it is preferred that the openings be reinforced. In one form, a secondary plate with a corresponding opening can be provided adjacent to the opening through the wall member. The secondary plate will typically be permanently attached to the removable wall member. Preferably, the periphery of the respective openings in the removable wall member and secondary plate are aligned in order to reinforce the periphery of the openings.

At least one transverse member is preferably provided in the rear portion of the vehicle body, above the level of the load deck. Preferably, a plurality of transverse members are provided. In one form, transverse members are preferably attached/mounted between the lower ends of the fixed posts. The transverse members will typically allow items to be placed into the rear portion of the vehicle body to be located on the transverse members, spacing the items from the load deck in order to allow access beneath the items when loaded into the vehicle body, for example using a forklift.

One or more transverse members may be provided at an upper end of the removable wall members. Preferably, one or more corner connectors may be provided within the rear portion of the vehicle body to attach transverse members and/or removable wall members relative to one or more of the fixed posts. Preferably the transverse members and/or one or more corner connectors are removable. The transverse members and/or one or more corner connectors are preferably provided to form a compartmentalised frame in the rear portion of the vehicle body.

Identifying indicium may be provided on any rearmost transverse member of the preferred compartmentalised frame in the rear portion of the vehicle body, in order to assist an operator to identify any component or item loaded into or to be loaded into any compartment.

Preferably, one transverse member is provided between adjacent fixed posts approximately centrally over the height of the fixed posts. An upper transverse member may be provided between adjacent fixed posts at or towards an upper end of the height of the fixed posts. As mentioned, the provision of transverse members will, in an embodiment, form an array of compartments in the rear portion of the vehicle body. In a preferred form, having 12 fixed posts, six elongate compartments extending the length of the rear portion of the vehicle body can be formed using an appropriate number of transverse members. Preferably, a lower row of three elongate compartments is formed and an upper row of three elongate compartments is formed. A configuration such as this is ideally suited for transport of elongate scaffold members used in a scaffold system.

Preferably, an upper part of the rear portion, above the preferred compartmentalised frame formed using the fixed posts, and between the preferred removable posts (above the fixed posts), can be left open. In this configuration, this open part is ideally suited to receive deck members of a scaffold system, for example.

When the preferred tailgate explained above is provided and moved into the closed position, the rear end of the preferred compartmentalised frame is closed preventing access to the rear end of the frame and also preventing items loaded into the frame being lost through the rear of the frame.

One or more wall members may be provided extending transversely at a forward end of the compartmentalised frame to close any one or more of the compartments at a forward end thereof.

A forward portion of the load deck may include one or more removable posts provided on the lateral sides of the forward portion. Preferably, one or more side doors can be mounted relative to the one or more removable posts. The provision of one or more side doors will typically enclose one or more parts of the forward portion of the vehicle body. The configuration of the one or more doors is preferably similar to the configuration of the removable wall members provided in the rear portion. The one or more side doors may be removable relative to the one or more removable posts.

A removable containing basket may be provided in the forward portion. In an embodiment, the removable containing basket may be provided with a load of components or items which can be loaded into the basket prior to loading the basket onto the vehicle body.

The removable containing basket is preferably provided with a number of walls defining an external shape of the removable containing basket. An interior volume of the removable containing basket is preferably divided into a number of receiving compartments or bins. The division of the interior volume can be achieved using one or more divider plates provided therein. Typically, a divider plate is a substantially planar plate. A stiffening bar may be provided extending along the top edge of the divider plate.

The removable containing basket may be manufactured on one or more rest members in order to space a lower portion of the removable containing basket from an upper side of the load deck when loaded into the vehicle body. This will preferably allow access beneath the removable containing basket to allow a forklift for example, to be used to load and unload the removable containing basket from the vehicle body. In one form, the rest members will preferably be rectangular hollow section. The rest members will typically be attached to an underside of the removable containing basket.

One or more removable barriers or frames may be provided in a forward portion of the vehicle body. Preferably, a removable barrier or frame will be provided at a rear end of the nearside of the forward portion in order to define a space to contain the preferred removable containing basket. A longitudinally extending separator panel may be located between the headboard structure of the vehicle body and the one or more removable barriers or frame to define a side extremity of the space to contain the preferred removable containing basket. The removable barriers or frames may be formed in any way but in one embodiment, a rectangular hollow section frame, formed from a number of members, can be used.

The removable containing basket will typically have a substantially planar, solid base wall. One or more drain holes may be provided through the base wall to allow water to drain through the removable containing basket rather being retained in any one or more of the compartments within the removable containing basket.

One or more and typically all of the walls of the removable containing basket are outwardly angled from the bottom of the wall to the top. The provision of outwardly angled walls will preferably allow the removable containing basket to be more easily positioned within the space provided in the forward portion of the vehicle body, during loading.

An upper edge of any external walls provided in the forward portion of the vehicle body may have an inwardly extending upper lip.

One or more compartments may be provided in the forward portion of the vehicle body. Typically, the or each compartment may be defined using one or more wall members. Any one or more compartment may be provided with a lid. In use, a compartment may be used to store one or more items, components or preferably tools required for assembly and/or disassembly of a scaffold system, for example.

The vehicle body having one or more features as explained above will preferably provide an easily reconfigurable body, capable of assuming a number of configurations, in order to receive transport a wide variety of components safely and securely. The vehicle body will also allow loading in a compartmentalised manner to allow an operator to easily identify the particular components required to use. Further, a demountable vehicle body can be preloaded and then simply mounted on a transport vehicle as required due to its preferred demountable configuration.

### DETAILED DESCRIPTION OF THE INVENTION

In order that the invention may be more clearly understood one or more embodiments thereof will now be described, by way of example only, with reference to the accompanying drawings, of which:

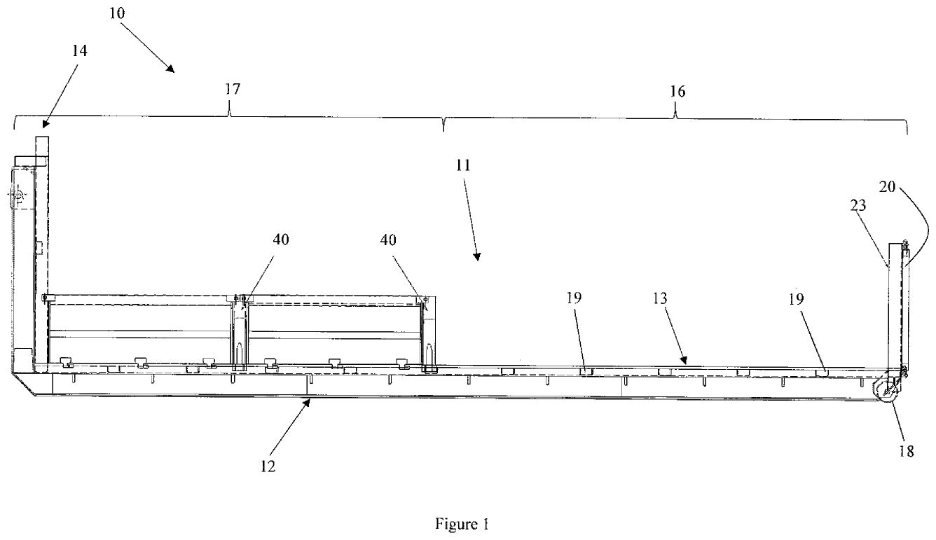

FIG. 1 is a side elevation view of a vehicle body according to an embodiment;

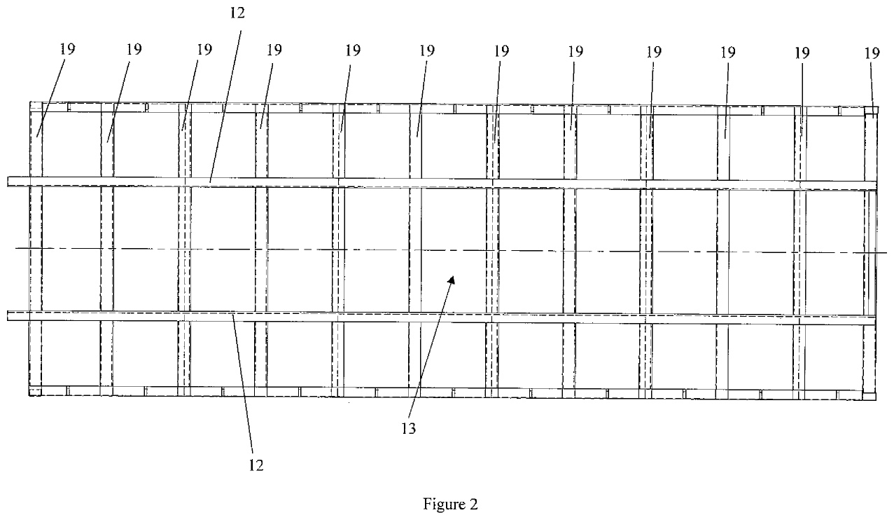

FIG. 2 is a view from beneath the vehicle body illustrated in FIG. 1;

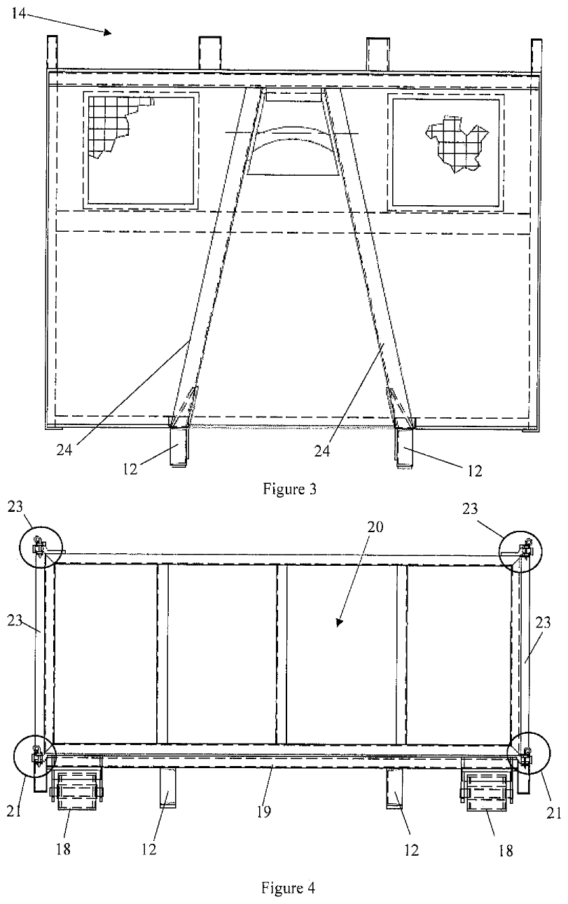

FIG. 3 is a front view of the vehicle body illustrated in FIG. 1;

FIG. 4 is a rear view of the vehicle body illustrated in FIG. 1;

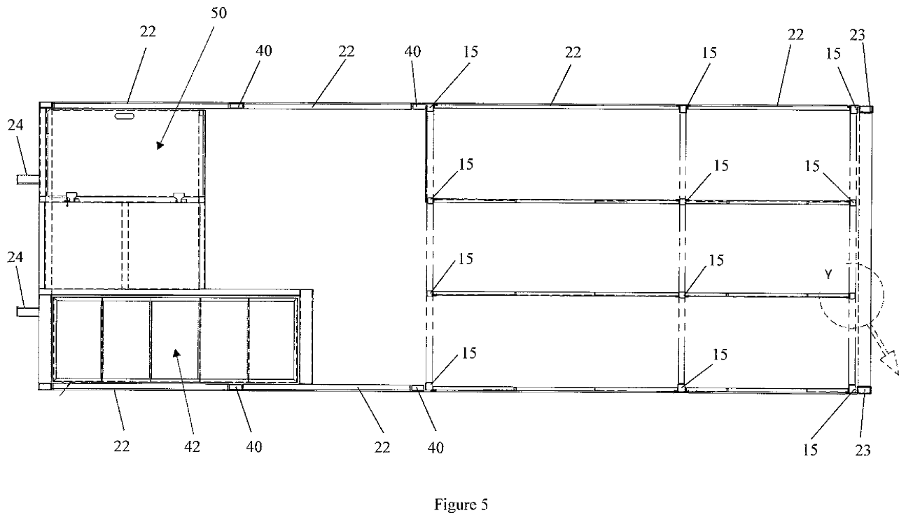

FIG. 5 is a top view of a vehicle body according to an embodiment;

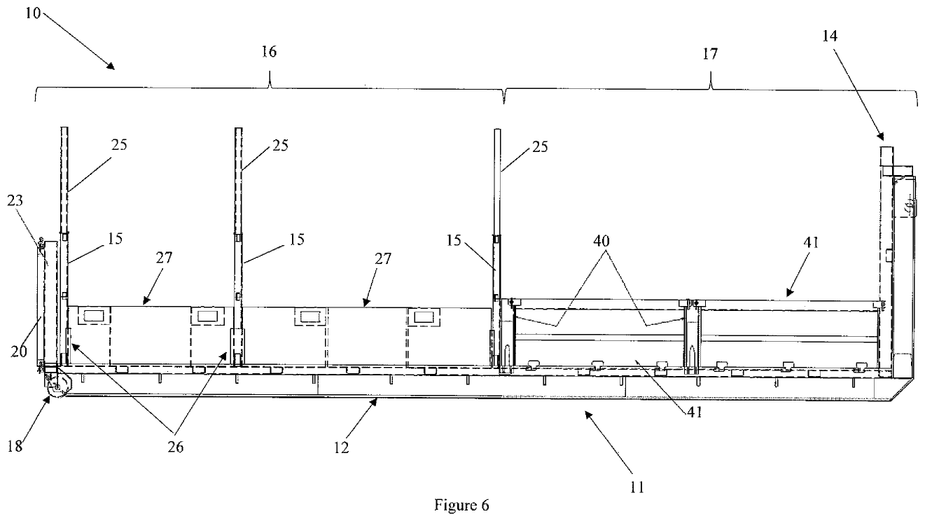

FIG. 6 is a side elevation view of the off side of the vehicle body illustrated in FIG. 5 with doors;

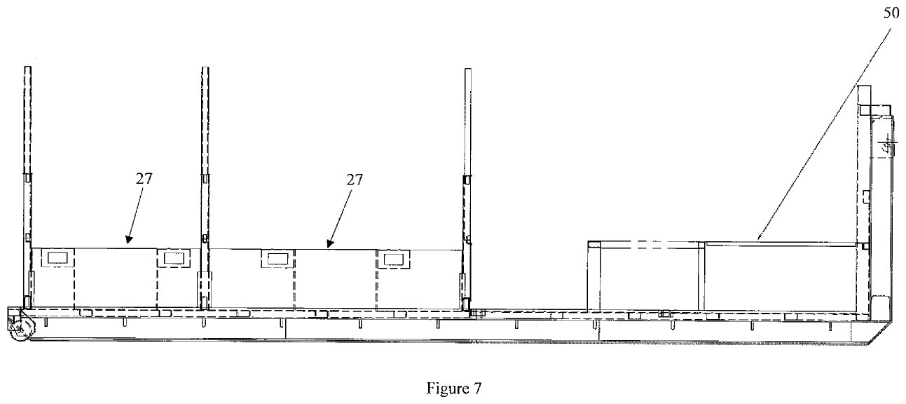

FIG. 7 is a side elevation view of the off side of the vehicle body illustrated in FIG. 5 without doors;

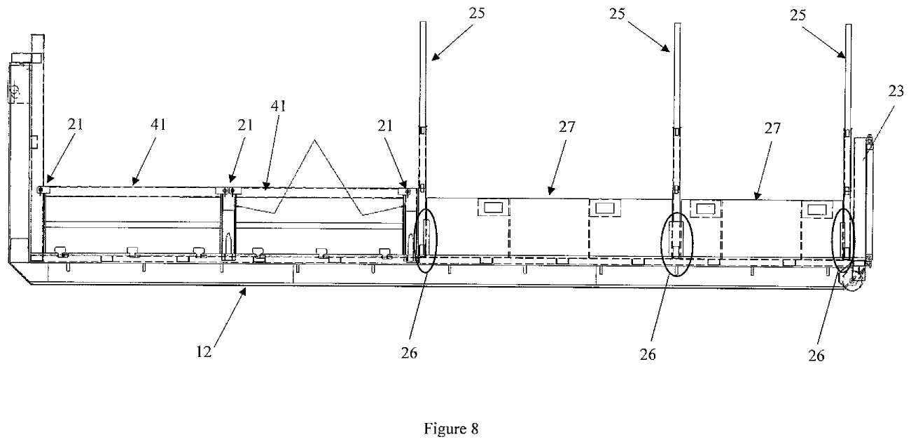

FIG. 8 is a side elevation view of the near side of the vehicle body illustrated in FIG. 5 with doors;

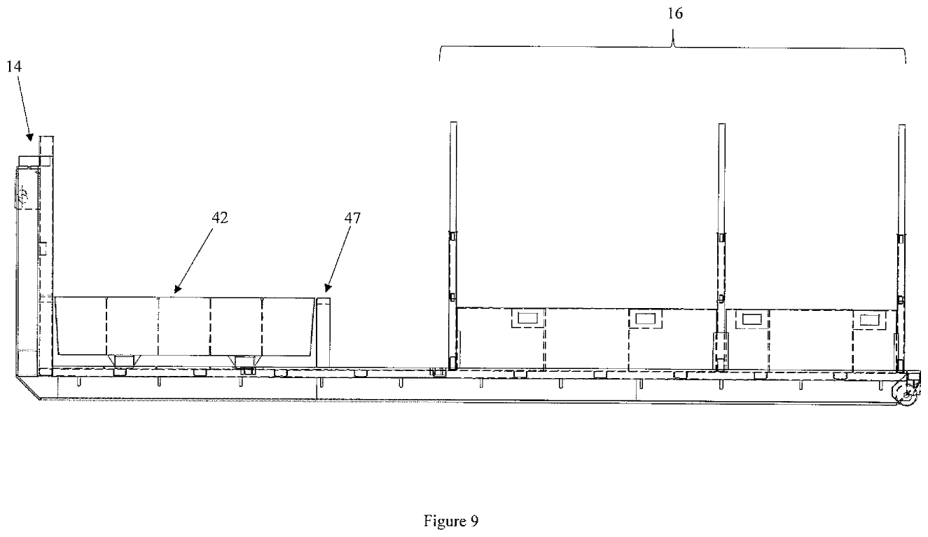

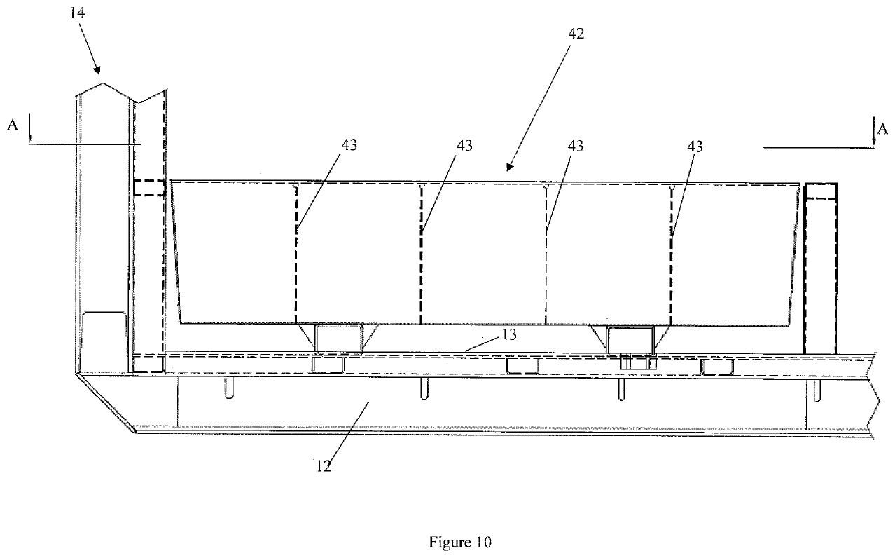

FIG. 9 is a side elevation view of the near side of the vehicle body illustrated in FIG. 5 without doors;

FIG. 10 is a side elevation view of a forward part of the near side of the vehicle body illustrated in FIG. 5 with basket in situ;

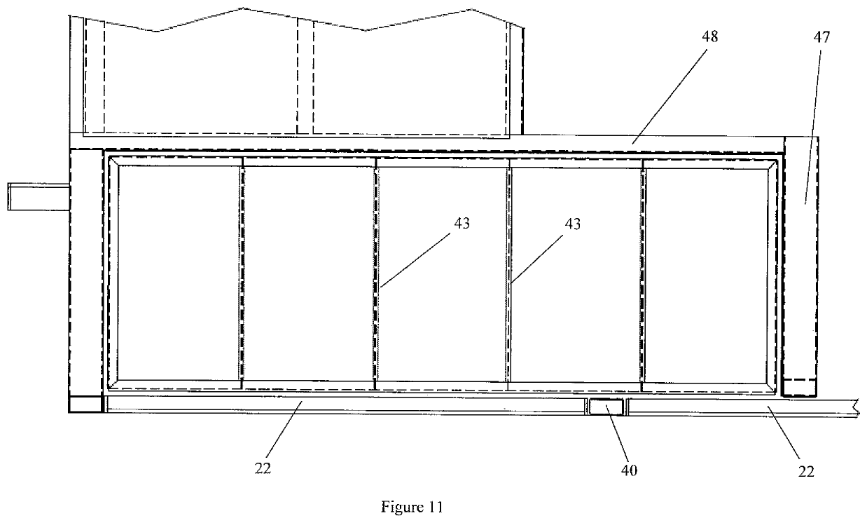

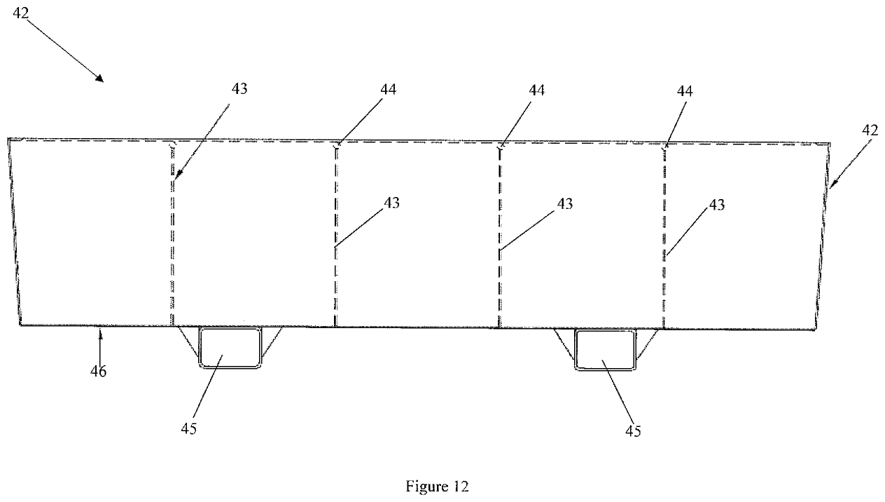

FIG. 11 is a plan view of the configuration illustrated in FIG. 10;

FIG. 12 is a side elevation view of a basket;

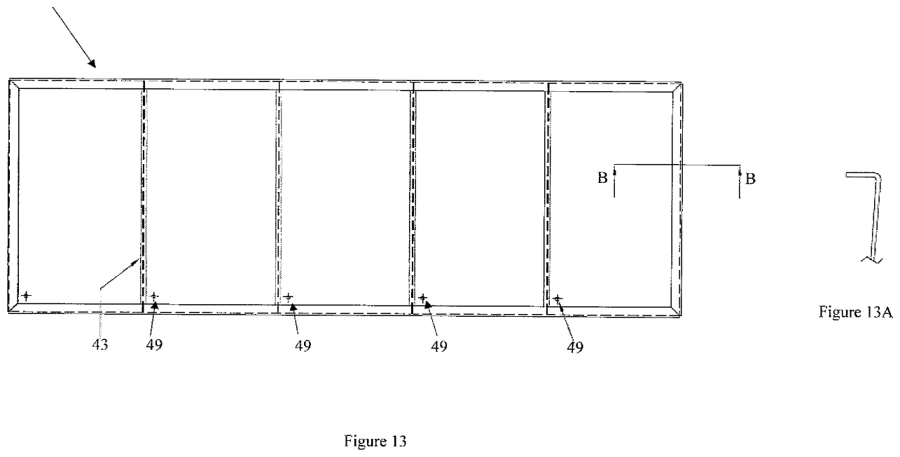

FIG. 13 is a plan view of the basket illustrated in FIG. 12 from line A-A;

FIG. 13A is a sectional view of the end wall illustrated in FIG. 13 along line B-B;

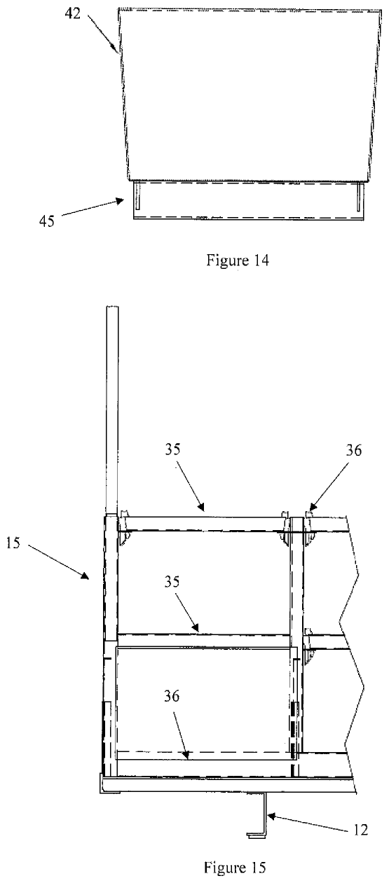

FIG. 14 is an end view of the basket illustrated in FIG. 12

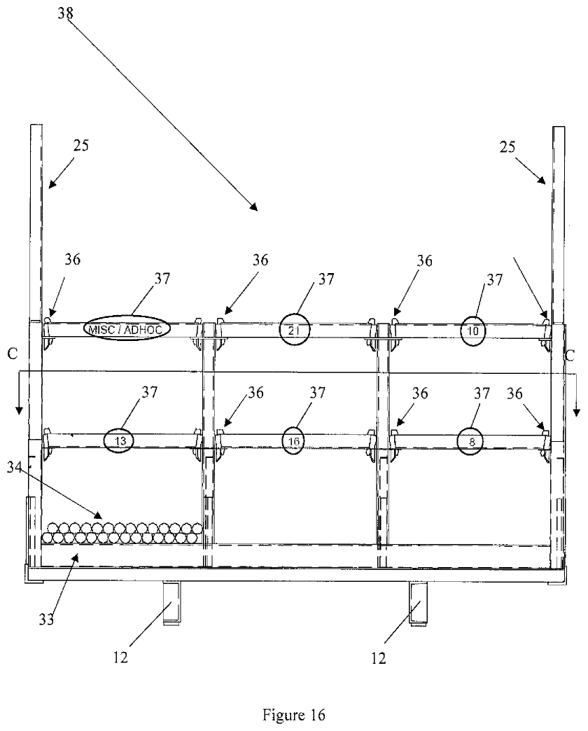

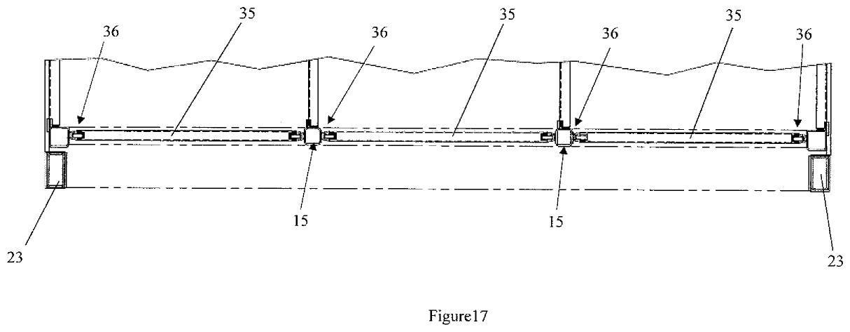

FIG. 15 is a sectional end view of the left side portion of the configuration illustrated in FIG. 16;

FIG. 16 is a view from the rear of the vehicle body illustrated in FIG. 9 with a frame mounted thereto;

FIG. 17 is a sectional view of the configuration illustrated in FIG. 16 along line C-C;

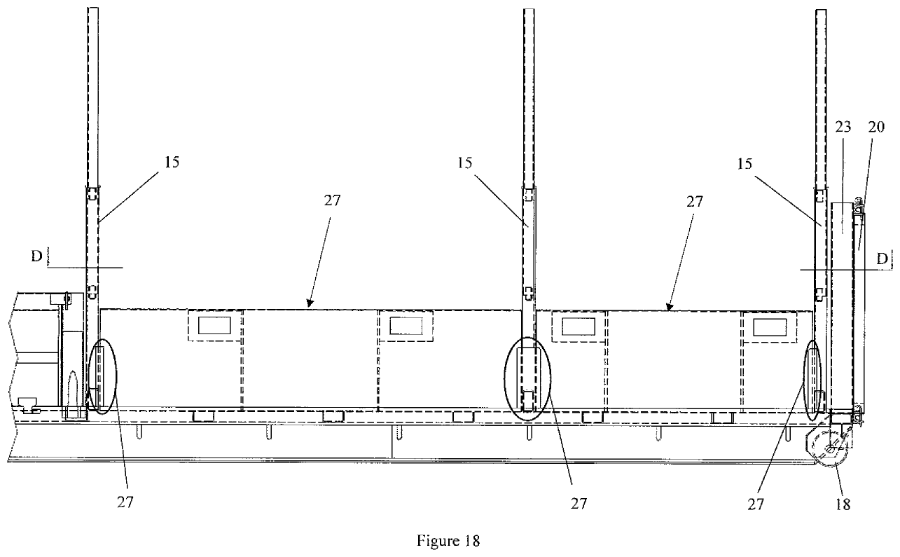

FIG. 18 is a side elevation view of a rear part of the near side of the vehicle body illustrated in FIG. 5 with doors in dotted lines;

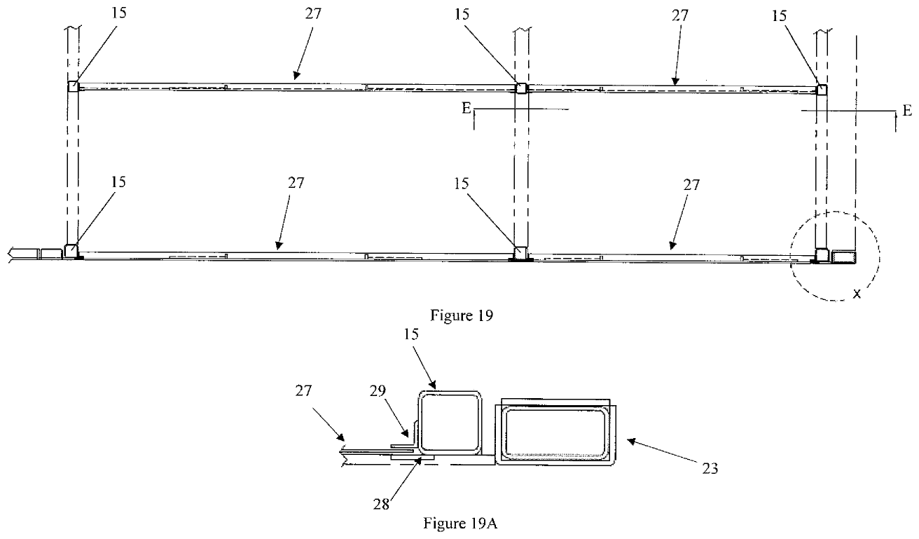

FIG. 19 is a plan view of the portion illustrated in FIG. 18 from line D-D;

FIG. 19A is a detail view of the portion illustrated in FIG. 19 and denoted X;

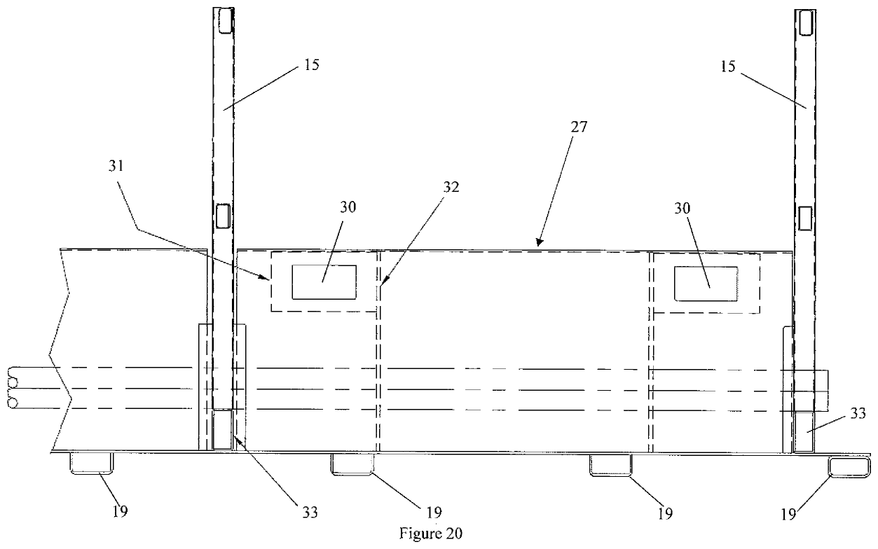

FIG. 20 is a detail view of the inner walls of the rear part of the configuration illustrated in FIG. 19 from Line E-E;

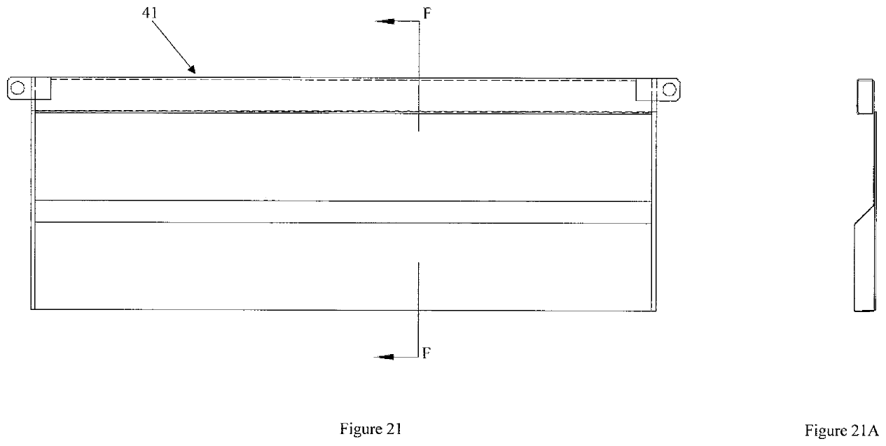

FIG. 21 is a side view of a forward side door from the embodiment illustrated in FIG. 8;

FIG. 21A is a sectional view of the forward side door illustrated in FIG. 21 along line F-F;

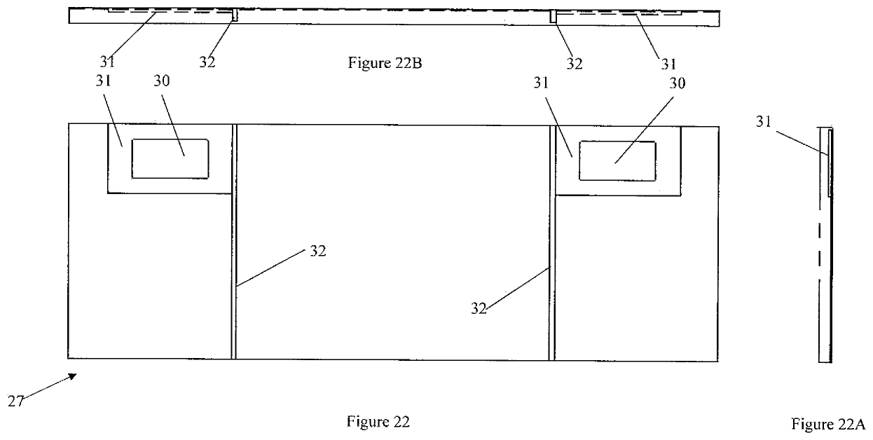

FIG. 22 is a side elevation view of a rear side door from the embodiment illustrated in FIG. 18;

FIG. 22A is an end view of the rear side door as illustrated in FIG. 22;

FIG. 22B is a plan view of the rear side door as illustrated in FIG. 22;

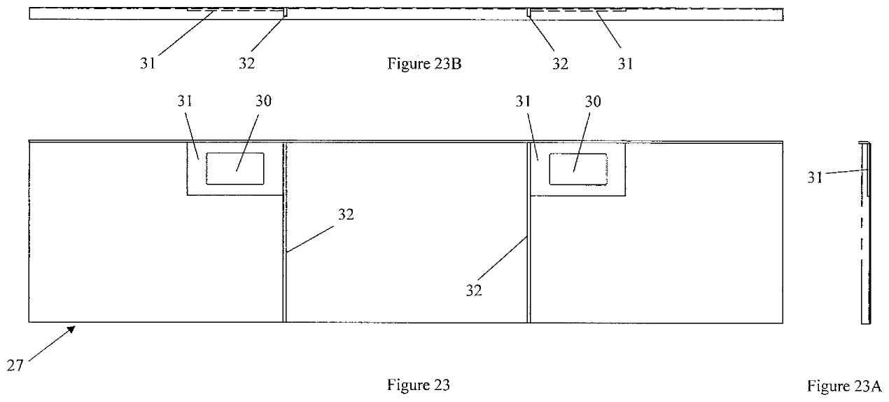

FIG. 23 is a side elevation view of a rear side door from the embodiment illustrated in FIG. 18;

FIG. 23A is an end view of the rear side door as illustrated in FIG. 23; and

FIG. 23B is a plan view of the rear side door as illustrated in FIG. 23.

The Figures show a reconfigurable vehicle body 10 of an embodiment. The illustrated vehicle body 10 comprises a main body 11, illustrated best in FIGS. 1 to 4. The main body 11 includes a pair of elongate main beams 12, a load deck 13 mounted relative to the elongate main beams 12 and a forward headboard structure 14 at a forward end of the load deck 13.

As shown in FIGS. 5 to 9 in particular, three pairs of fixed posts 15 are provided in a rear portion 16 of the load deck 13, one fixed post 15 of each pair located at an opposed lateral side of the load deck 13 and extending upwardly relative to the load deck 13.

In the illustrated embodiment, the vehicle body 10 is a demountable truck body, configured to be mounted and demounted from a truck (not shown).

Whilst the reconfigurable vehicle body of the present invention is adaptable to a wide variety of uses, the Figures show a vehicle body which is particularly adapted for use in delivery of scaffold system components, allowing a scaffold system to be assembled from the delivered components.

In the illustrated form, the main body 11 has a sledge configuration with the main beams 12 providing a pair of runners or rests upon which the main body 11 rests when on a ground surface (or while not on a vehicle).

A pair of wheel members 18 are provided towards a rear end of the main body 11 of the illustrated configuration. In use, a forward end of the main body 11 can be lifted upwardly, with the rear end of the main body 11 supported on the wheel members 18 while the main body 11 is drawn onto or driven onto a truck chassis. As shown, the wheel members 18 extend further rearwardly than the rear end of the elongate main beams 12 such that when the forward end of the main body 11 is lifted, the rear end of the main body 11 is supported on the wheel members 18.

One or more draw points or assemblies (not shown) are typically provided on a forward end of the vehicle body 10. The one or more draw points or assemblies may be used to winch or otherwise draw the preferred demountable vehicle body onto a transport vehicle. In one simple embodiment, one or more plates provided with an opening relative to which a winch cable can be attached, could be used as a draw point.

As shown, the preferred pair of elongate main beams 12 extend substantially parallel to one another, spaced apart over the length of the main body 11. The elongate main beams 12 are preferably the main load-bearing beams provided in the structure of the main body 11. Although any cross-sectional shape may be utilised for the elongate main beams 12, a C-beam is normally used for each.

As illustrated in FIG. 2 in particular, a plurality of transversely extending members 19 are provided above the elongate main beams 12 and attached thereto. The transversely extending members 19 extend laterally beyond the spacing of the elongate main beams 12 and define the width of the load deck 13. The transversely extending members 19 support the load deck 13 relative thereto.

Each of the transversely extending members 19 are hollow and preferably substantially rectangular in cross section as shown, formed from rectangular hollow section (RHS). Each transversely extending member 19 is typically unitary over its length.

As mentioned above, the load deck 13 of the main body 11 is normally provided on top of the transversely extending members 19.

A tailgate 20 is provided relative to a rear end of the main body 11. The tailgate shown in FIG. 4 can be pivoted from the top edge or the bottom edge if required, or all four securing mechanisms 21 (shown in FIG. 4 as a pin each with an R clip) can be released at once allowing removal of the tailgate 20 completely.

One or more side rail members 22 may be provided at the lateral side ends of each of the transversely extending members 19.

The load deck is typically formed from a number of planar plates, which in the illustrated embodiment, are provided in a single plane. The load deck plates are mounted above the transversely extending members 19 and attached directed thereto in the illustrated embodiment.

A removable tailgate post 23 is provided at either lateral side of the main body 11, at a rear end of the load deck 13. The removable tailgate posts 23 provide an abutment for the tailgate 20 when the tailgate is in the closed position.

As shown, the headboard structure 14 is a substantially planar structure. The headboard structure illustrated in FIG. 3, includes a pair of members 24 which extend substantially perpendicularly to the elongate main beams 12. When viewed from the front, the pair of members 24 converge toward an upper portion of the headboard structure 14. A lower end of each of the pair of members 24 is mounted to, or relative to a forward end of each of the respective elongate main beams 12.

As shown in FIGS. 6 to 9, the headboard structure is substantially perpendicular to the load deck 13 including one or more plate members mounted relative to a rear side thereof, facing the load deck 13 to provide an abutment surface at a forward end of the load deck 13.

All of the components of the main body of the preferred embodiment are manufactured from a material which is strong but light, suitably a light metal. The components are attached relative to one another using an appropriate method. For example, welding may be used if permanent attachment is required. Bolts may be used if temporary attachment is required.

As shown in FIG. 6 in particular, the load deck 13 of the vehicle body 10 is generally divided into a forward portion 17 and a rear portion 16. The forward portion 17 and rear portion 16 are configured differently as shown and dependent upon the load to be carried. In the embodiment in which the vehicle body 10 is specifically adapted for transport of parts of a scaffold system as illustrated, the rear portion 16 of the load deck 13 is configured to carry elongate scaffold members and a forward portion 17 of the load deck 13 is configured to carry connectors and/or shorter scaffold members. The load deck 13 shown in the Figures is divided into the forward portion 17 and rear portion 16 in a 45:55, forward portion: rear portion split.

In the illustrated embodiment, three pairs of fixed posts 15 are provided, namely a front pair of fixed posts, a rear pair of fixed posts and a central pair of fixed posts located between the front pair and the rear pair of fixed posts. In the illustrated embodiment, the central pair of fixed posts are located closer to the rear of the load deck 13 than the front.

As illustrated in the plan view in FIG. 6. one fixed post of each pair is located at opposed lateral sides of the load deck 13 and is designated an outside fixed post. Two intermediate fixed posts are provided between the outside fixed posts of a pair. The intermediate fixed posts may be provided equally spaced across the width of the load deck between the outside fixed posts. In this preferred configuration, four fixed posts are provided substantially in line across the width of the load deck. Preferably, three sets of four fixed posts are provided in the rear portion 16 of the load deck 13.

It is preferred that the fixed posts 15 in the rear portion 16 of the load deck 13 form a regular array as illustrated in FIG. 6 which has 12 fixed posts arrayed in three lines spaced over the length of the rear portion, each line having four fixed posts spaced across the width of the load deck 13.

As shown, the rear pair of fixed posts 15 is located inside the removable tailgate post 23 provided on either lateral side of the rear of the load deck 13.

The fixed posts 15 are mounted to/relative to the load deck 13 and extend above the level of the load deck 13. In one form, the fixed posts 15 each extend above the load deck 13 approximately 1 m to 1.2 m. The fixed posts are at least partially hollow, preferably configured as square hollow section (SHS).

A removable upper post section 25 is mountable relative to an upper end of each fixed post 15. The removable upper post sections 25 are at least partially received within an upper portion of each fixed post 15 with a stop or abutment configuration provided spaced from the lower end of the removable upper post section 25 in order to limit insertion of the upper post section 25 into the fixed post 15. The removable upper post section 25 will normally be shaped and dimensioned to be closely received within a hollow upper end of each fixed post 15. A friction fit is preferred.

The vehicle body of the illustrated embodiment includes a wall receiving assembly 26 positioned relative to each of the fixed posts 15 to receive a removable wall panel 27. The wall receiving assemblies 26 in the rear portion 16 of the load deck 13 are best illustrated in FIGS. 18 to 19A.

Each wall receiving assembly 26 illustrated includes a pair of spaced apart receiving arms. In one form, the receiving arms are substantially planar plates. The wall receiving assembly 27 is dimensioned to allow insertion and removal of a removable wall panel 27. Typically, the wall receiving assembly 26 is substantially vertically oriented such that a removable wall panel 27 can be inserted by sliding the wall panel 27 into the wall receiving assembly 26 from above. There will generally be a small clearance between the thickness of the removable wall panel 27 and the spaced apart receiving arms.

In one form illustrated in FIG. 19A, an outer receiving arm 28 of each wall receiving assembly 27 is a planar plate mounted relative to an outside wall of the SHS fixed post 15.

An inner receiving arm of each wall receiving assembly 27 is provided by one of the walls of an angled member 29. The angle member 29 shown in FIG. 19A is a substantially L-shaped member with a pair of walls which are substantially perpendicular to one another. One of the walls of each angle member 29 is positioned parallel to and spaced from the outer receiving arm 28 in order to define a receiving gap into which a removable wall panel 27 can be inserted.

As shown in FIG. 19A, both the outer receiving arm 28 and angle 29 with the inner receiving arm are attached to a lower portion of each fixed post 15, with the outer receiving arm attached or mounted to an outer wall of each fixed post 15 and the angle 29 is attached or mounted to a side wall of the fixed post 15 in order to position the inner receiving arm relative to the outer receiving arm 28 as shown in FIG. 19A.

The front pair of fixed posts and rear pair of fixed posts illustrated in FIG. 18 each have one wall receiving assembly 27 and the central pair of fixed posts 15 have a wall receiving assembly 27 extending from each end thereof, facing the respective front pair of fixed posts or rear pair of fixed posts.

A wall receiving assembly is preferably provided on all intermediate fixed posts as well as the outside fixed posts in order to allow the rear portion 16 of the load deck 13 to be divided into a number of compartments spaced across the width of the load deck 13 (as shown in FIG. 16), through the provision of removable wall panels 27.

Each of the removable wall panels 27 is normally formed from a strong, rigid material such as a light metal for example. In a preferred form, each of the removable wall members 27 provide in the rear portion of the vehicle body 10, is or includes a metal plate.

Typically, a single removable wall member 27, examples of which are illustrated in FIGS. 22 to 23A is provided between each fixed post 15, longitudinally.

As shown in FIGS. 22 to 23A in particular, each removable wall member 27 will typically include a pair of lifting openings 30 provided through the removable wall member 27. Provision of a pair of spaced apart lifting openings 30 will typically allow a mechanism or machine such as a forklift having a pair of spaced apart tines to be used to insert and remove the removable wall members 27, which may be quite heavy, depending upon size and material of construction. Preferably the pair of lifting openings 30 are spaced apart a regular distance in order to accommodate forklift tines which may have a fixed separation distance.

Where lifting openings 30 through the removable wall member 27 are provided, it is preferred that the openings 30 be reinforced. A secondary reinforcing plate 31 with an opening corresponding to the lifting opening 30 can be provided adjacent to the lifting opening 30 through the wall member 27. The secondary reinforcing plate 31 is normally permanently attached to the removable wall member 27. Preferably, the periphery of the respective openings in the removable wall member 27 and secondary reinforcing plate 31 are aligned in order to reinforce the periphery of the lifting openings 30. A pair of reinforcing ribs 32 is also provided on an inner surface of the removable wall member 27.

A number of transverse members 33 are provided in the rear portion 16 of the vehicle body 10, above the level of the load deck 13. In one form, transverse members 33 are attached/mounted between the lower ends of the fixed posts 15. As shown in

FIG. 16, the transverse members 33 allow items 34 to be placed into the rear portion 16 of the vehicle body 10 located on the transverse members 33, spacing the items 34 from the load deck 13 in order to allow access beneath the items 34 when loaded into the vehicle body 10, for example using a forklift.

As illustrated in FIGS. 15 and 16, transverse members 35 can be provided at an upper end of the removable wall members 27. Preferably, corner connectors 36 are provided within the rear portion 16 of the vehicle body 10 to attach transverse members 35 (and possibly upper removable wall members) relative to the fixed posts 15 to form a compartmentalised frame in the rear portion of the vehicle body, as shown in FIG. 16. Preferably, the transverse members 35 and/or one or more corner connectors 36 are removable.

Identifying indicium 37 can be provided on any rearmost transverse member 35 of the preferred compartmentalised frame in the rear portion 16 of the vehicle body 10, in order to assist an operator to identify any component or item loaded into or to be loaded into any compartment.

As shown in FIG. 16, one transverse member 35 is provided between adjacent fixed posts 15 approximately centrally over the height of the fixed posts 15 and an upper transverse member 35 is provided between adjacent fixed posts 15 at or towards an upper end of the height of the fixed posts 15.

In the preferred illustrated form having 12 fixed posts 15, six elongate compartments extending the length of the rear portion 16 of the vehicle body 10 can be formed using an appropriate number of transverse members 35 with a lower row of three elongate compartments and an upper row of three elongate compartments. A configuration such as this is ideally suited for transport of elongate scaffold members used in a scaffold system.

Preferably, an upper part of the rear portion 16, above the preferred compartmentalised frame formed using the fixed posts (illustrated in FIG. 16), and between the removable posts 25 (above the fixed posts 15), can be left open. In this configuration, this open part 38 is ideally suited to receive deck members of a scaffold system, for example.

When the preferred tailgate 20 explained above is provided and moved into the closed position, the rear end of the compartmentalised frame is closed, preventing access to the rear end of the frame and also preventing items loaded into the frame being lost through the rear of the frame.

One or more wall members 39 may be provided extending transversely at a forward end of the compartmentalised frame to close any one or more of the compartments at a forward end thereof as illustrated in FIG. 5.

A forward portion 17 of the load deck 13 may include removable posts 40 provided on the lateral sides of the forward portion 17. Preferably, side doors 41 can be mounted relative to the removable posts 40 and secured in place using securing mechanisms, 21 similar to those used for the tailgate 20. The provision of one or more side doors 41, a preferred form of which is illustrated in FIGS. 21 and 21A, will typically enclose one or more parts of the forward portion 17 of the vehicle body 10. The side doors 41 are preferably removable relative to the removable posts 40.

A removable containing basket 42 may be provided in the forward portion 17 as illustrated in FIGS. 9 and 10. In an embodiment, the removable containing basket 42 may be provided with a load of components or items which can be loaded into the basket 42 prior to loading the basket 42 onto the vehicle body 10.

The removable containing basket 42 is preferably provided with a number of walls defining an external shape of the removable containing basket 42. An interior volume of the removable containing basket 42 is preferably divided into a number of receiving compartments or bins using one or more divider plates 43 provided therein. Typically, each divider plate 43 is a substantially planar plate. A stiffening bar 44 may be provided extending along the top edge of the divider plate 43.

The removable containing basket 42 may be manufactured on one or more rest members 45 in order to space a lower floor 46 of the removable containing basket 42 from an upper side of the load deck 13 when loaded into the vehicle body 10 as illustrated in FIG. 10. This configuration allows access beneath the removable containing basket 42 to allow a forklift for example, to be used to load and unload the removable containing basket 42 from the vehicle body 10. In the form illustrated in the Figures, the rest members 45 are rectangular hollow section (RHS) attached to an underside of the removable containing basket 42.

One or more removable barriers or frames may be provided in a forward portion of the vehicle body to define a storage space for the basket 42. Preferably, a removable barrier or frame 47 is provided at a rear end of the nearside of the forward portion 17 in order to define a space to contain the removable containing basket 42. A longitudinally extending separator panel 48 may be located between the headboard structure 14 of the vehicle body 10 and the removable barrier or frame 47, to define a side extremity of the forward portion to contain the removable containing basket 42.

The removable containing basket 42 will typically have a substantially planar, solid base wall 46. One or more drain holes 49 are provided through the base wall 46 to allow water to drain through the removable containing basket 42 rather being retained in any one or more of the compartments within the removable containing basket 42.

Typically, all of the walls of the removable containing basket 42 are outwardly angled from the bottom of the wall to the top. The provision of outwardly angled walls allows the removable containing basket 42 to be more easily positioned within the space provided in the forward portion of the vehicle body, during loading.

As shown in FIG. 13A, an upper edge of the external walls of the basket 42 have an inwardly extending upper lip.

A lockable compartment 50 may be provided in the forward portion of the vehicle body on the opposite side to the basket 42. Typically, the compartment 50 is typically defined using one or more wall members and will normally be provided with a lid. In use, the compartment 50 may be used to store one or more items, components or preferably tools required for assembly and/or disassembly of a scaffold system, for example.

The one or more embodiments are described above by way of example only. Many variations are possible without departing from the scope of protection afforded by the appended claims.

1. A reconfigurable vehicle body comprising:
a) A main body including
i. At least one elongate main beam;
ii. A load deck mounted relative to the at least one elongate main beam and divided into a forward portion and a rear portion, the forward portion and rear portion differently and dependent upon the load to be carried; and
iii. At least one forward headboard structure at a forward end of the load deck;
b) At least two pairs of fixed posts provided in the rear portion of the load deck, one fixed post of each pair located at an opposed lateral side of the load deck and extending upwardly relative to the load deck;
c) A wall-receiving assembly positioned relative to each of the fixed posts; and
d) At least one removable wall member locatable relative to at least a pair of wall-receiving assemblies to define at least one receiving compartment within the width of the load deck; and
e) one or more removable posts provided on the lateral sides of the forward portion of the load deck.

2. The reconfigurable vehicle body as claimed in claim wherein the vehicle body is a demountable body, configured to be mounted and demounted from a vehicle.

3-4. (canceled)

5. The reconfigurable vehicle body as claimed in claim 1 wherein the main body has a sledge configuration with a pair of elongate main beams each providing a runner or rest upon which the main body rests, a plurality of transversely extending members provided above the elongate main beams and attached relative thereto and wherein the load deck is mounted relative to the transversely extending members.

6-7. (canceled)

8. The reconfigurable vehicle body as claimed in claim 1 further comprising a tailgate assembly relative to a rear end of the main body, the tailgate assembly movable between a lowered position allowing access to the rear end of the main body and an elevated position in which the rear end of the main body is closed.

9. The reconfigurable vehicle body as claimed in claim 1 wherein the headboard structure extends substantially perpendicular to the load deck providing an abutment surface at a forward end of the load deck.

10. The reconfigurable vehicle body as claimed in claim 1 further comprising one or more intermediate fixed posts provided between the fixed posts in a pair, substantially in line with the fixed posts.

11. The reconfigurable vehicle body as claimed in claim 10 wherein the intermediate fixed posts are removable.

12. The reconfigurable vehicle body as claimed in claim 10 wherein the fixed posts form a regular array in a rear portion of the load deck.

13. The reconfigurable vehicle body as claimed in claim 1 wherein the fixed posts are elongate and at least partially hollow.

14. The reconfigurable vehicle body as claimed in claim 13 further comprising one or more removable upper post sections at least partially received within an upper portion of each fixed post.

15. The reconfigurable vehicle body as claimed in claim 1 wherein each wall receiving assembly includes a pair of spaced apart receiving arms spaced apart to allow insertion and removal of a removable wall panel.

16. The reconfigurable vehicle body as claimed in claim 15 wherein the wall receiving assembly is substantially vertically oriented such that a removable wall panel can be inserted by sliding the wall panel into the wall receiving assembly from above.

17. The reconfigurable vehicle body as claimed in claim 15 wherein the wall receiving assembly comprises an outer receiving arm and an angle portion including an inner receiving arm attached to a lower portion of each fixed post.

18. The reconfigurable vehicle body as claimed in claim 1 wherein each removable wall member includes at least one lifting opening provided through the removable wall member.

19. The reconfigurable vehicle body as claimed in claim 1 further comprising at least one transverse member provided in a rear portion of the vehicle body, extending above the level of the load deck.

20. The reconfigurable vehicle body as claimed in claim 1 further comprising one or more upper transverse members and one or more corner connectors provided within a rear portion of the vehicle body to attach the one or more upper transverse members and/or removable wall members relative to one or more of the fixed posts to form a compartmentalised frame in the rear portion of the vehicle body.

21. (canceled)

22. The reconfigurable vehicle body as claimed in claim 1 further comprising one or more side doors mounted relative to the one or more removable posts.

23. The reconfigurable vehicle body as claimed in claim 1 further comprising a removable containing basket provided in a forward portion of the load deck, the containing basket provided with one or more rest members in order to space a lower portion of the removable containing basket from an upper side of the load deck when loaded into the vehicle body.

24. The reconfigurable vehicle body as claimed in claim 1 further comprising one or more removable barriers or frames provided in a forward portion of the vehicle body to define one or more receiving spaces in the forward portion.

25. The reconfigurable vehicle body as claimed in claim 1 further comprising one or more securable compartments provided in a forward portion of the vehicle body.
